(19) United States
(12) Patent Application Publication
(10) Pub. No.: US 2024/0321057 A1
(43) Pub. Date: Sep. 26, 2024

(54) PERPETUAL TOURNAMENT ONLINE GAME

(71) Applicant: Andrew Marsch, Glen Ellyn, IL (US)

(72) Inventor: Andrew Marsch, Glen Ellyn, IL (US)

(21) Appl. No.: 18/611,252

(22) Filed: Mar. 20, 2024

Related U.S. Application Data
(60) Provisional application No. 63/453,258, filed on Mar. 20, 2023.

(51) Int. Cl. G07F 17/32

(52) U.S. Cl. CPC G07F 17/3279; G07F 17/3223; G07F 17/3237; G07F 17/3255

(57) ABSTRACT

A method for conducting a multiplayer online tournament includes matchmaking that allows players to have multiple player instances simultaneously. Each player instance for a player has an associated win streak. A matchmaking process preferentially attempts to match player instances with the highest common win streak. When a game between matched player instances is conducted, the winner has their win streak incremented while the loser has their player instance deleted. Where no common win streak is available between two matched players, a new player instance can be created with a win streak of zero. By allowing multiple win streaks for a player simultaneously, the continuous play of a battle royale style tournament is created while maintaining the fairness of a bracket style tournament.

### CROSS REFERENCE TO RELATED APPLICATIONS

This application claims priority to U.S. Provisional Patent Application Ser. No. 63/453,258 filed 20 Mar. 2023, the entire contents of which are incorporated herein by reference.

### FIELD OF THE INVENTION

The present invention relates to a multi-player game that can be played perpetually by multiple players in an online environment.

### BACKGROUND

Online games provide amusement and entertainment to players as well as provide a source of revenue to game hosts particularly through advertising. Player v player tournament games are particularly attractive to users and contest hosts alike. Tournament games provide players the opportunity to compete against each other for enjoyment, prestige, and even rewards. Likewise, tournaments have provided contest hosts with publicity, advertising opportunity, and ultimately revenue generation. Current contest/reward applications are based around estimating returns, prepaid reward, or dividing reward pools among winners. Many current models involve a game where any number of players begin and players are eliminated each round until the final round occurs. After the final round a reward is split amongst all players that successfully passed the final round. This can be seen in trivia apps such as TriviaHQ, Swagbucks Live, and Lucky Trivia Live. Other rewards apps involve games where players play a one-person game, such as solitaire or bingo and are rewarded cash. Other alternative tournament models require users to pay an entry fee and compete for a prize pool generated from the users' entry fees. While this methodology carries less financial risk than estimating a prize pool, it restricts the user base to only people willing to pay the entry fec. What is required is a tournament system that provides a reward, can scale to the amount of players involved, and doesn't rely on prefunded prize pools.

### SUMMARY OF ONE EMBODIMENT OF THE INVENTION

### Advantages of One or More Embodiments of the Present Invention

The various embodiments of the present invention may, but do not necessarily, achieve one or more of the following advantages:
Provide a progressive tournament style of play;
Provide player selection and matching for a game that matches players of equivalent progress;
Provide a play style that allows players to have multiple entries in a game.

These and other advantages may be realized by reference to the remaining portions of the specification, claims, and abstract.

### Brief Description of One Embodiment of the Present Invention

In one embodiment, there is provided a method for conducting a multiplayer tournament. The method may comprise establishing a pool of eligible players wherein players of the pool of eligible players may have multiple win streaks simultaneously associated to them. Searching the pool of eligible players can match a set of players meeting a matching criteria. A win streak can be staked for each matched player of the set of players. The game may be conducted between the set of players and at least one winner may be determined. The win streak of the at least one winner may be incremented.

In one embodiment, there is provided a method for matchmaking in an online game between multiple players. The method may comprise establishing a pool of eligible players for an online game wherein players of the pool of eligible players may have multiple win streaks simultaneously associated to them. A request may be received from a first player of the pool of eligible players to play a match of the online game. At least one second player with a win streak equal to at least one of the win streaks associated to the first player may be determined and matched against the first player for the online game. One of the equal win streaks may be set as a stake for the match. The online game may be conducted and at least one winner of the match may be determined. The staked win streak for the at least one winner of the match may be incremented.

In one embodiment, there is provided a method for conducting a multiplayer tournament. The method may comprise establishing a pool of eligible player instances wherein each player instance is associated with a player and a win streak, and wherein a player may have multiple player instances associated to them simultaneously. The method may comprise matching a set of player instances from the pool of eligible player instances according to matching criteria and conducting a game between the set of players associated with the matched player instances. At least one winning player of the set of players may be determined as a winner of the game and the win streak of the matched player instance associated with each of the at least one winning player may be incremented.

In one embodiment, there is provided a system comprising a server configured to communicate with a plurality of player devices through a network and a database that is operatively associated with the server and that stores player data. The server may be programmed to establish a pool of eligible players wherein players of the pool of eligible players may have multiple win streaks simultaneously associated to them. Searching the pool of eligible players can match a set of players meeting a matching criteria. A win streak can be staked for each matched player of the set of players. The game may be conducted between the set of players and at least one winner may be determined. The win streak of the at least one winner may be incremented.

In one embodiment, there is provided a system comprising a server configured to communicate with a plurality of player devices through a network and a database that is operatively associated with the server and that stores player data. The server may be programmed to establish a pool of eligible players for an online game wherein players of the pool of eligible players may have multiple win streaks simultaneously associated to them. A request may be received from a first player of the pool of eligible players to play a match of the online game. At least one second player with a win streak equal to at least one of the win streaks associated to the first player may be determined and matched against the first player for the online game. One of the equal win streaks may be set as a stake for the match. The online game may be conducted and at least one winner of the match may be determined. The staked win streak for the at least one winner of the match may be incremented.

In one embodiment, there is provided a system comprising a server configured to communicate with a plurality of player devices through a network and a database that is operatively associated with the server and that stores player data. The server may be programmed to establish a pool of eligible player instances wherein each player instance is associated with a player and a win streak, and wherein a player may have multiple player instances associated to them simultaneously. The method may comprise matching a set of player instances from the pool of eligible player instances according to matching criteria and conducting a game between the set of players associated with the matched player instances. At least one winning player of the set of players may be determined as a winner of the game and the win streak of the matched player instance associated with each of the at least one winning player may be incremented.

In one embodiment, there is provided a method for use in a multiplayer tournament. The method may comprise selecting a set of players from an eligible player pool, wherein players within the eligible player pool may have multiple win streaks simultaneously associated to them. A highest common win streak amongst the selected set of players may be determined and set as a stake for a game.

In one embodiment, there is provided a method for matchmaking for a game comprising establishing a pool of eligible players wherein players of the pool of eligible players may have multiple win streaks simultaneously associated to them, searching the pool of eligible players to match players meeting a matching criteria, determining a highest common win streak amongst the selected set of players, and setting the highest common win streak as a stake for the game.

In one embodiment, there is provided a method for conducting a multiplayer tournament. The method may comprise establishing a pool of eligible players wherein players of the pool of eligible players may have multiple win streaks simultaneously associated to them. The method may further include searching the pool of eligible players to match a set of players within a matching criteria and establishing a win streak at stake for each matched player of the set of players. A game may be conducted between the set of players and at least one winning player of the set of players may be determined as a winner of the game. The win streak at stake for each of the at least one winning player may be incremented.

In one embodiment, there is provided a method for conducting a multiplayer tournament. The method may comprise establishing a pool of eligible player instances wherein each player instance is associated with a player and a win streak, and wherein a player may have multiple player instances associated to them simultaneously. A set of player instances from the pool of eligible player instances may be matched according to matching criteria and a game may be conducted between the set of players associated with the matched player instances. At least one winning player of the set of players may be determined as a winner of the game. The win streak of the matched player instance associated with each of the at least one winning player may then be incremented.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a prior art bracket style of matchmaking;

FIG. 2 substantially depicts a prior art battle royale style of matchmaking;

FIG. 3 substantially depicts a perpetual open tournament style of matchmaking;

FIG. 4 substantially depicts a perpetual open tournament style of matchmaking that allows multiple player instances;

FIG. 5 substantially depicts the perpetual open tournament of FIG. 4 with the time dependencies removed;

FIG. 6 substantially depicts a player dashboard of a gaming app featuring a perpetual open tournament;

FIG. 7 substantially depicts a matchmaking process flow;

FIG. 8 substantially depicts a faceoff between two players with multiple win streaks and a common win streak;

FIG. 9 substantially depicts an initial faceoff interface for a gaming app;

FIG. 10 substantially depicts an interface during game play;

FIG. 11 substantially depicts a targeted matchmaking procedure;

FIG. 12 substantially depicts an eligible player pool; and

FIG. 13 substantially depicts a system for implementing a multiplayer online game tournament.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

There will be described herein a game that provides an entertaining experience for casual players who may play in small sessions throughout the day. The game mechanics are designed for every person to be able to play the game and for the player to enter and re-enter the game play at times that suit them. The game is referred to herein as a Perpetual Open Tournament, which draws inspiration from two other tournament types. These tournament types are the conventional bracket tournament and the Battle Royale tournament.

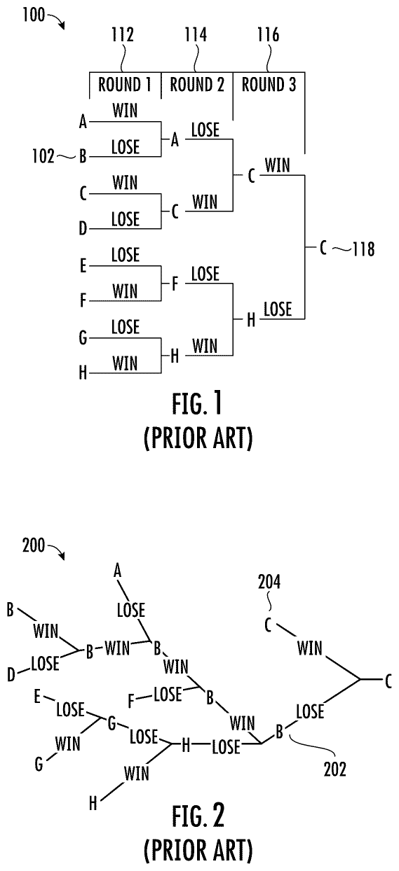

A conventional bracket tournament, an example of which is shown generally at 100 in FIG. 1, works as follows. First, a set number of participants 102 are chosen. Then, the participants 102 are organized in a rigid bracket system of matches to be played in rounds. FIG. 1 shows three rounds, round 1 112, round 2 114, and round 3 116. Each match of round 1 112 contains two participants that engage in a contest. The winner of the match advances to the next round 114 while the loser is eliminated from the tournament. The winners are then reorganized into new matches against each other. There are half the number of participants in this new round. This process continues until there is only one participant left 118.

There are many disadvantages to this configuration. First, the tournament needs to be preorganized with a set number of participants. Second, if one game gets delayed, the tournament would either require a forfeit from a participant or it would be unable to continue. Third, there is no easy way to add new players to an ongoing tournament. Fourth, the tournament size and number of rounds is controlled by the number of participants.

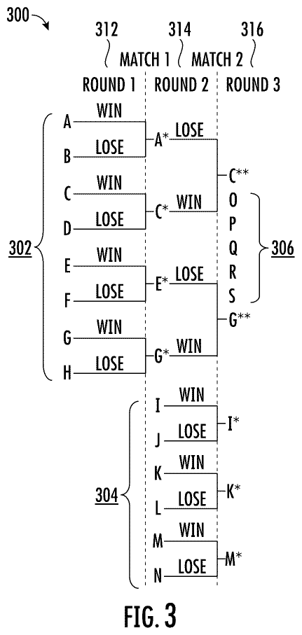

Another option would be a Battle Royale tournament. In this example, participants challenge each other at random. Players are eliminated each match until there is one player left. This allows for a continuous stream of new participants and they can leave the tournament without causing any delay to the game. However, this comes at the cost of fairness and match predictability. A Battle Royale tournament is shown in FIG. 2. In a Battle Royale tournament 200, contestant B 202 was eliminated after 5 matches while contestant C 204 succeeded after only participating in one match. Two potential win conditions of this tournament style are to be the last one remaining or to be the first to have a number of victories in a row. A number of victories in a row is called a win streak. While the chances of a player obtaining a win-streak is the same for any tournament, the total number of contestants involved in a specific battle royale win streak is completely unpredictable. The winner could either defeat a set of new contestants on their first matches or defeat champions that were one win away from having the required win streak. While this method has simple tournament matchmaking compared to other tournament styles, a large disadvantage of this tournament style is that it is vulnerable to coordinated cheating. A group of players could purposely lose matches to give one player a large win streak.

A tournament game play and matchmaking method that addresses at least some of the above problems will be described herein. A loose tournament structure, comprised of multiple instances per player, with a strong incentive mechanism and proper revenue generation can create an environment in which players can compete in tournaments for rewards that are guaranteed through advertising revenue generated by the players themselves. Such a structure can allow player entry into a competition, and the potential to receive a reward, based on the number of number of ads a player has watched, i.e. the amount of revenue the player has directly contributed. A player tournament formed and operated in this manner can provide a reward, can scale to the amount of players involved, and doesn't rely on prefunded prize pools.

The tournament, referred to herein as a Perpetual Open Tournament (POT), combines aspects of the bracket tournament and battle royale tournament styles with a few key additions. In one embodiment of a perpetual open tournament, shown generally at 300 in FIG. 3, contestants can match against any player that has the same win streak. As shown in FIG. 3, contestants with the same ‘*’ count (win streak) are eligible to play against each other in a match. FIG. 3 also shows that new players can join in any round before a match. In this example, contestants A-H 302 joined in round 1 312, contestants I-N 304 joined in round 2 314, and contestants O-S 306 joined in round 3 316 This ends up creating a bunch of small conventional tournament brackets within a Battle Royale-like system. This style of tournament also reduces the impact of coordinated cheating. A coordinated group of players would still have to play the same amount of games to achieve the same win streak as a normal player base.

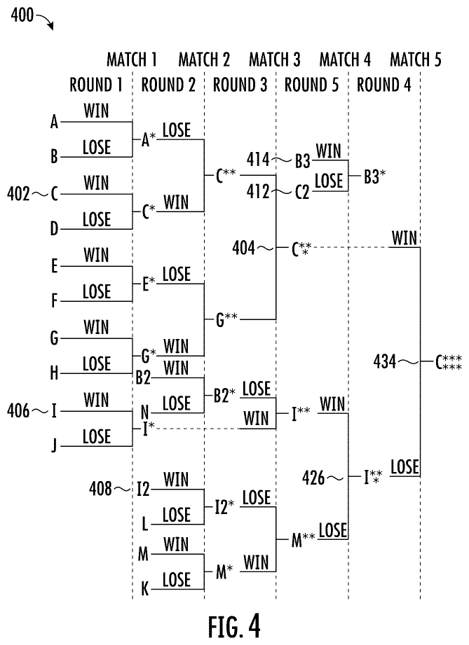

By itself, the requirement that players can only play against players on the same win streak would cause an unsolvable or an extremely slow tournament as the remaining players could end up in win streaks that are different from other players. Contestants with high win streaks would have to wait unjustifiably long time periods until new players joined and contested to a point that a new player had a compatible win streak to an old player. Thus, the tournament could become slow and boring for advanced players, providing a disincentive to continue playing. This problem is negated by allowing a player to create multiple player instances, with each player instance having an associated win streak. Player instances allow the player to reenter the tournament when there are no other players available at their highest win streak (s) without sacrificing their high win streak. Also, a defeated player is able to rejoin at any time by creating a new player instance with a zero win streak. A hypothetical tournament 400 with this ruleset is shown in FIG. 4. In this example, additional player instances of a player, created as a result of either defeat or lack of eligible opponents, are shown with a number at the end of the player name. For example, player A's second player instance is labeled as A2.

In the example tournament of FIG. 4, player C 402 wins matches in each of the first three rounds and is depicted prior to round 4 as C*** (player C, win streak=3) 404. However, at round 4, there is no other player instance in the eligible player pool with an equivalent three win streak. Player instance C is thus placed on hold. Instead, a new player instance C2 412 is created with a zero win streak. At match 4, player instance C2 is matched to player instance B3 414 (also of zero win streak) and at match 4, player instance C2 loses to player instance B3. Meanwhile, player instance I 406 wins in Round 1 but is unmatched for Round 2 and thus a new player instance I2 408 is created at round 2. At round 3, the first instance for Player I continues their win streak by winning each of rounds three and four. At round 5, both of player instance C*** 404 and I*** 426 have three wins and can therefore be matched. In match 5, player instance C*** wins, increasing their win streak to four C**** 434.

Allowing players to have multiple player instances simultaneously, each instance having its own associated win streak, transforms the dynamic of tournament play. Firstly, this allows each player to have multiple win streaks going at once. Second, players are now incentivized to play and reenter as much as possible. Third, large brackets can be created and completed with a very small or constantly changing player base. Fourth, players with active win streaks can quit the tournament entirely without harming tournament progress. And further, the number of matches in every win streak is easily predictable and monetizable. Of course, player instances of the same player that have evolved to have equivalent win streaks are prevented from playing each other.

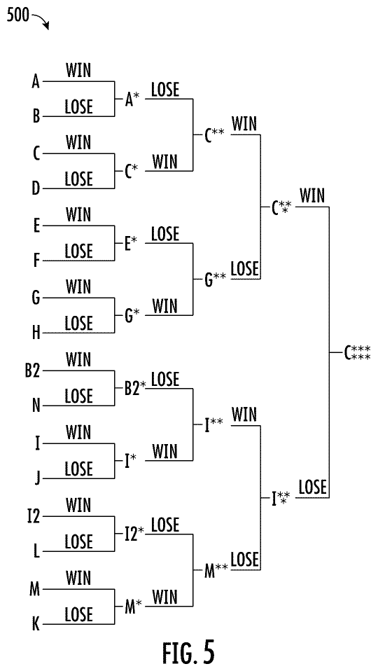

In order to understand the monetization potential of a Perpetual Open Tournament, certain properties of a win streak must be calculated. When the time factor is omitted, a POT win streak can be rearranged to resemble a conventional single elimination tournament bracket, as shown generally at 500 in FIG. 5. All win streaks, regardless of new players entering or how long other contributing win streaks are put on hold, will resemble this model. With this understanding of a win streak structure the calculations for its properties become possible.

The total number of player vs player matches Mp required to reach any point along a player's win streak can be calculated as:

$${M}_{p} = {2}^{n} - 1$$

Where Mₚ is the number of PVP matches and n is the win streak count.

For Player C's 4 win streak, the number of PVP matches is:

$${M}_{p} = {2}^{4} - 1 = 16 - 1 = 15 .$$

Each match can be considered to require two player activities. The total number of player activities (P) for the Mₚ matches is:

$$P = 2 \times {M}_{p}$$

Table 1 shows the growth of Mp and P with respect to n., with P including reentries and new entries.

TABLE 1

| | Number of PVP | Number of player |
|---|---|---|
| Win Streak (n) | matches (Mp) | instances (P) |
| 1 | 1 | 2 |
| 4 | 15 | 30 |
| 5 | 31 | 62 |
| 10 | 1,023 | 2046 |
| 15 | 32,767 | 65,534 |
| 20 | 1,048,575 | 2,097,150 |
| 25 | 33,554,431 | 67,108,862 |

This methodology can also be applied to games other than 1V1. This could include 1v1v1, 1v1v1v1 and so on and team games. The formula above can be expanded to incorporate all forms of games including but not limited to team games, multiple person free for all, and multiple team free for all.

In this expanded formula, the total number of matches Mp required to reach any point along a team's win streak can be calculated as:

$${M}_{p} = ( {T}^{n} - 1 ) / ( T - 1 )$$

Where Mₚ is the number of PVP matches, n is the win streak count and T is the number of teams participating in each match (please note that in a free for all game, the team would consist of 1 person).

In this expanded formula, the total number of player activities (P) for the Mₚ matches is:

$$P = I \times T \times {M}_{p}$$

Where P is the number of player activities, I is the number of players per team, Mₚ is the number of PVP matches, n is the win streak count and T is the number of teams participating in each match.

In all types of single elimination tournaments the odds of achieving the win streak Wₚ is the same:

$${W}_{p} = {( 1 / T )}^{n}$$

Where is Wₚ the odds of achieving the win streak, T is the number of teams, and n is the win streak count.

The exponential growth of player activities for growing win streaks creates opportunities for monetization. If a perpetual open tournament style were to incorporate a commercial between every match for every active player the number of ad instances Av can be calculated as equal to the number of player activities. This means that in order to get a win streak of 4, a total of 15 games must be played and 30 ads are shown to players.

By matching the number of player activities to ad revenue, it is possible to incentivize game play by offering cash prizes or other rewards.

### Monetization

A mobile game can take advantage of the Perpetual Open Tournament (POT) to offer cash prizes greater than traditional gameshows from ad revenue. In the traditional game show, a small group of contestants engage in a contest for a prize. The prizes and game show overhead is paid for by ad revenue from the viewership of a large audience. This is risky because the game show can lose money from awarding a prize if nobody watches the show. In a POT mobile game, the contestants are the audience that watches the ads before every match. The success of any monetization structure will be dependent on maximizing the tolerable amount of advertisements each contestant watches. The POT has a predictable number of potential ad views because a set number of games is required to achieve a certain win streak. In a battle royale style game, the payout would typically need to be less than half of the ad revenue generated per game to remain profitable.

The payout structure of the POT is dependent on revenue generated by ad viewership. Because of this, the ad schedule needs to be optimized. While it may be tempting to play an ad after every match, this could quickly discourage some contestants if they have 50% of their playtime dedicated to ads. A static ad frequency is a simple solution to this problem but it has some drawbacks. For example, a static ad frequency (Af) of 0.25 would mean playing an ad once every 4 games. On one hand, some people can tolerate much higher ad frequencies for long play sessions. This would mean that less money would be generated from them than possible. On the other hand, if a player is playing poorly, a set of improperly timed ads can cause the player to quit early. A dynamic ad frequency based off of contestant information and game session data would be ideal for keeping contestants engaged for as long as possible with the most ads they can tolerate.

A dynamic ad frequency (Afd) may be calculated from various factors. For example, some potential factors are the player's largest wins and losses (WLa), the player's win percentage (Pa), the player's streak holdings (Ha), the player's typical activity (Ta). Each of these factors may be expressed in a percentage and multiplied to define the Afd. There could either be a single formula where the Afd is calculated or there could be a set of equations where the effective Afd is defined by the maximum, minimum, or weighted average of the equation set. A potential base equation for this concept is shown below:

$${A}_{fd} = {P}_{a} * {H}_{a} * W {L}_{a} * {T}_{a}$$

The win percentage factor, Pa, is the factor in how the player's win percentage effects the ad frequency. This factor could be defined by a weighted set of smaller factors. These could be the total overall win percentage (Pt), the session win percentage (Ps), and the recent 10 games win percentage (Pr). Weighted constants (a0, a1, a2, b0, b1, b2 etc. . . . ), which are defined as lower case letters with a numeric subscript, can be adjusted to make the equation reasonably match a dataset. Pa could be calculated with the equation below:

$${P}_{a} = {a}_{0}^{\frac{{a}_{1}}{{P}_{t}^{{a}_{2}}}} * {b}_{0}^{\frac{{b}_{1}}{{P}_{s}^{{b}_{2}}}} * {c}_{0}^{\frac{{c}_{1}}{{P}_{r}^{{c}_{2}}}} * {d}_{0}^{\frac{{d}_{1}}{( {P}_{s} / {P}_{t} ) {d}_{2}}} * {g}_{0}^{\frac{{g}_{1}}{( {P}_{r} / {P}_{s} ) {d}_{2}}}$$

The player holdings factor (Ha) is how the change in total holdings effects the ad frequency. A players total holdings is a weighted sum of the player's win streaks. Each win streak is valued by the number of win matches contained within the streak (Mp). This is shown in Table 1. For example, a single win streak would be worth 1, and a 15 match win streak would be worth 32,767. The session holdings ratio (Hs) is the current total holdings divided by the total holdings before the current play session (Pr). Weighted constants, which are defined as lower case letters with a numeric subscript, can be adjusted to make the equation reasonably match a dataset. The equation for the player holdings factor (Ha) is shown below:

$${H}_{a} = {i}_{0}^{\frac{{i}_{1}}{{H}_{s}^{{i}_{2}}}}$$

The win loss factor (WLa) is how the largest loss and win effects the ad frequency. The sizes of the win or loss is classified by the streak level. This factor takes into account the largest win and loss for the player's history (Wt and Lt), the largest win and loss in the session (Ws and Ls), the largest win and loss in the last 10 matches (Wr and Lr) and the largest loss and win in the last 5 turns (Wi and Li). Weighted constants, which are defined as lower case letters with a numeric subscript, can be adjusted to make the equation reasonably match a dataset. The equation for WLa is shown below:

$${WL}_{a} = {j}_{0}^{\frac{{j}_{1}}{{( {W}_{t} / {L}_{t} )}^{{j}_{2}}}} * {k}_{0}^{\frac{{k}_{1}}{{( {W}_{s} / {L}_{s} )}^{{k}_{2}}}} * {l}_{0}^{\frac{{l}_{1}}{{( {W}_{r} / {L}_{r} )}^{{l}_{2}}}} * {q}_{0}^{\frac{{q}_{1}}{{( {W}_{i} / {L}_{i} )}^{{q}_{2}}}}$$

The last main factor would be the game time factor (Ta). This factor is how the game duration and frequency effects the ad rate. This is comprised of the time since the last play session (Tl), the duration of the current session (Ts), and the time of the average game session (Tm). The equation for this is below:

$${T}_{a} = {r}_{0}^{\frac{{r}_{1}}{{( {T}_{m} / {T}_{s} )}^{{r}_{2}}}} * {u}_{0}^{{u}_{1} * {T}_{l}^{{u}_{2}}}$$

Not only does this mathematical model allow for the ad rate to be optimized, it also helps maintain player engagement. Now the player can be enticed back into the game loop after a large loss with a higher match frequency.

A particular embodiment of a game in accordance with the present disclosure will now be described. This embodiment presents an online 1v1 multiplayer game. The game at the core of the implementation may be based on a game of chance or a game of skill, such as the well known rock/papers/scissors game. Rock/paper/scissors is considered a non-random game of chance because, while it appears to be based on random selections, player selections and non-random human behaviors form an element of the game, and thus the game has a degree of strategy and psychology, in particular as the players partake in a larger number of contests in each match. Similar games could be two-up, odds/evens, any of several known card games, etc. Each match between two players may be played as a series of individual contests of the game with the winner decided as the best of x contests. The number of contests may be dependent on the current win streaks of the players. Each match victory of the player will add to a winning streak while every defeat removes a winning streak.

The game may be completely free and incorporate ads between some matches based on the ad frequency calculations described above.

Player engagement can be encouraged and enhanced by providing an attractive user interface. In one embodiment, win streaks may be represented as towers. Each time a player adds to their win streak, the height of their respective tower may be increased. As stated above, a player is able to have multiple player instances. Thus, each player instance may be represented by a tower and the sum of player instances, represented by multiple towers, may be displayed as a city.

To grow a winning streak/tower, a player must face off against a player with the same size win streak/building. In a player match, the player stakes their win streak. If the player wins, an additional level is added to their building. If a player loses, their building is destroyed since the player's win streak is now over. When a player reports eligible for match making and the player does not have buildings of the same height as potential matches, or any building at all, a new streak of level zero will be created, and the winner of that match earns a level one building.

From a player perspective, the game may have multiple goals. One goal may be to attain a tower height of a minimum threshold. Towers may be redeemable for prizes of value, e.g. cash, goods, or services. Goods or services may be provided by game sponsors. In one embodiment, achieving a threshold minimum tower height may make the player eligible to enter a tournament for cash or other valuable prizes. If a player achieves a tower height/win streak that meets the tournament entry requirements, the tower may be locked so that it is not entered into subsequent matches. The tower may be locked automatically upon reaching the tournament entry height. Alternatively, the player may elect to lock the tower, or maintain the tower unlocked so that it can be put at stake in subsequent matches. For example, higher and higher towers may provide advantages in the tournament entry, in terms of tournaments seedings, number of matches required to win the tournament, higher level tournaments with associated higher level prizes, or other advantages. Thus, a player may wish to continue placing a high tower at stake, with the risk that the tower may be destroyed.

Another goal may be to build a city of multiple towers. In one embodiment, a city meeting threshold requirements may be redeemable for cash or other prizes of value. In one embodiment, a city of multiple towers may enable a player to enter a tournament, even if no single tower has attained the minimum threshold height for tournament entry. The accumulation of tower heights may be considered for tournament entry. The accumulation may factor that higher towers have a higher proportional value based on their level of difficulty to attain. For example, a tower height of 2 might be 2 points, while a tower height of 5 might be worth 10 points.

Another goal may be to maintain a high position on a leaderboard. Leaderboard positions may be dependent on one or both of maximum tower height and city size. Prizes of value may be awarded based on leaderboard positions.

As stated above, the game will typically be free to download and free to play. The game provider may earn revenue through ads placed before all matches or before matches according to the ad placement models discussed above. In addition, the game provider may provide bonuses to players for a small payment. Bonuses may be paid for by money received from players. Bonuses may also be earned by players, for example by winning games, watching additional ads, etc. Coins may be awarded to players to allow the player to spend or redeem their bonus when they desire. In various embodiments, coins may be redeemed for:

### 1. Building Protection

Prevents building from being destroyed after a round if the player loses. Used before first move is played in a round. Different cost depending on what building is being saved.

### 2. Building Salvage

Allows player to “salvage” a building at the end of a round for a lesser building when the player loses.

### 3. Building Frenzy

Upon winning, a building will receive two levels. Paid at beginning of round.

### 4. Building Save

Prevents building from being entered into matchmaking. This option is useful when saving a building to combine it with another for the next level building. (Combining buildings results when a person has two of the same buildings and pays coins to combine them).

The game may be offered as a downloadable application for a mobile device. Users would be able to download this Mobile Game App from an appropriate app store and would be able to become registered members for free. The app may be supported across multiple platforms such as iPhone, Android, etc. A web browser version of the game may also be offered.

### Splash Screen

The application will start with an appealing and interactive splash screen, which shall display the app's name and logo. The splash screen's concept is that it covers the time while the app is loading and it shows the company logo to promote the app.

### Sign Up

The user would have to input the information in various fields such as Username, Email, Password, Terms of Service, etc. One or more of these fields, such as the email address may be used as a unique identity. Once registered, the user may log in to the app. The user may also be able to register through various social networks such as Facebook, Google, etc.

### Dashboard

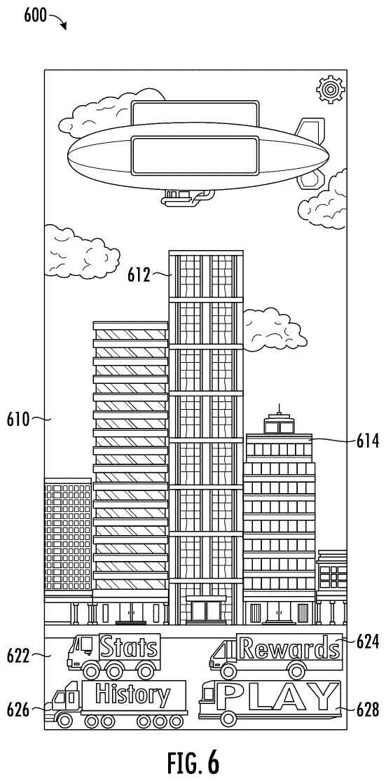

After access to this app, the user will land on the player dashboard, where users will be able to control their play account. An example of the player dashboard is shown in FIG. 6. The dashboard may show the current state of the player's city 610, including specific towers 612, 614. The dashboard 600 may also allow the player to select buttons to see player stats 622, rewards 624 and history 626. These buttons may be presented as vehicles on a roadway, in keeping with the cityscape theme. The player may also select to play 628, which will enter the player into a matchmaking round. Prior to matchmaking, the player may be presented with one or more ads to view.

The dashboard may include additional buttons (not shown) that allow the user to see settings, edit their profile, etc. In various embodiments, a degree of configuration may be allowed to the user, enabling the user to create a particular look for their city.

Through the player dashboard, the player may choose to combine towers. Rules may govern which towers may be combined. For example, towers may be required to be of equal height and may be combined to be a single tower of one level higher. The dashboard may also allow the player to lock towers, governed by rules such as the player may only lock two towers at a time. The rules may further only allow a fixed number of these operations per week for free, with additional operations requiring a monetary input from the player, a viewing of additional advertisements, or some other action that represents value to the game host.

### Game Flow Process

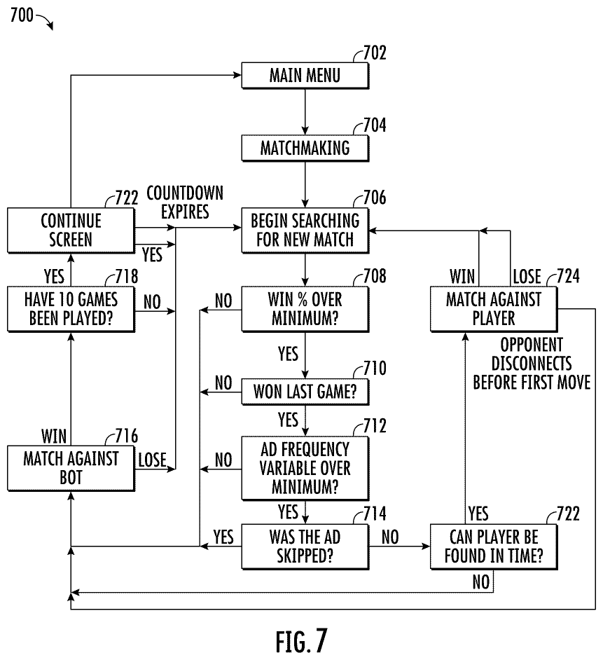

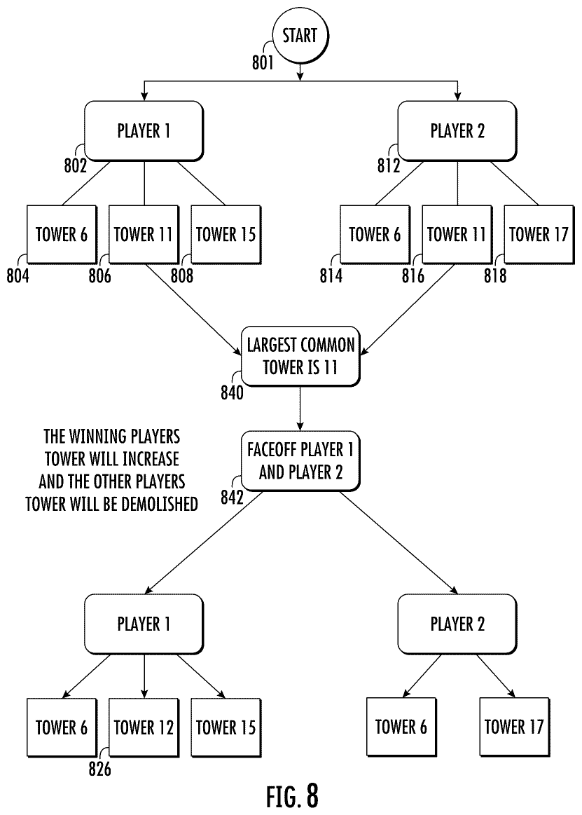

The flow process of this game is relatively simple, easily comprehended and attractive to the user. The process of the game chooses an active user or a bot to play against. Once a match is created, the players engage in a 1v1 set of games in a best-of-style. The best of game size will be determined by size of the two towers in play. If the player selects to a play a game, the play flow may proceed as shown in the flowchart 700 of FIG. 7. At step 702, a player selects to play a game from the main menu. The process then enters matchmaking 704 and may play an ad to the player at this time. The app then begins searching for a new match 706. Different methodologies for matchmaking will be described in more detail below, however, these methodologies may be governed by various requirements. These requirements will determine whether the player is matched against another player or a bot. At step 708, the process determines if the player's win % is above a minimum requirement. At step 710, the process determines if the player won their last game. At step 712, the process determines if the player's ad frequency variable is over a minimum. If the answer to any of these determinations is no, then the player is matched against a bot 716. The process can also determine if an ad was skipped (step 714) and if so, the player is also matched against a bot.

If the player loses to the bot or beats the bot but has not played more than a predetermined number of games (e.g. 10 games) against a bot (determined at step 718), then the process returns to step 706 to begin searching for a new match. If the player has played more than 10 games against the bot, the player may be asked (step 720) if they wish to continue to new matches (706) or return to the main menu (702).

The ad frequency variable takes into account both how the player is doing and how likely the player is to leave the game/leave from an ad. Given that the player is unable to determine if they are paired with a bot or not, guaranteed victories would comfort the player and reduce their chances of quitting. Also, if the ad frequency was low enough, the player could advance to a high level and win a prize without contributing to the prize pool. Thus, it can be preferable to keep the player in the lower levels, with matches (and potentially with guaranteed victories) against bots until the player's ad frequency variable has achieved a minimum.

If the player passes all the requirements for a player v player match, then the player is entered into a league and an attempt to match to another player is made (step 722). If no player match is found, a bot match is created (step 716). Otherwise, a player v player match is created (step 724). If the opponent disconnects before the first move, then the player is matched to a bot. Otherwise, the match is conducted and a winner determined. The process then returns to step 706 to search for a new match. The player's stats may be updated to reflect the outcome of the match. For example, if the player wins, the tower height may be incremented by one level. If the player loses, the player's tower may be demolished.

The tower that is played is the largest common tower. For example, as shown in FIG. 8, a match starts 801 and player 1 802 has level 6, 11 and 15 towers 804, 806, 808 and player 2 812 has level 6, 11 and 17 towers 814, 816, 818. The match determines 840 that the tower that is in play, or at stake in the match, is the level 11 tower of each player 806, 816. If in the faceoff 842, player 1 wins, the player 1's level 11 tower is incremented to level 12 826 and player 2's level 11 tower is demolished. If the players have no common towers, then a level 0 building plot will be in play. The winner of a level 0 match will receive a level 1 tower in their city while the loser will receive nothing and their respective plot will stay empty. This will allow players to have a virtually unlimited amount of towers in their cities. A particular advantage of this style of tournament play and matchmaking is that it allows for any player to be able to play against any other player regardless of the players' game progress.

According to the process of FIG. 7, if a player loses a match (say Player 2 in the example of FIG. 8 discussed above) then their next match must be against a bot, by virtue of step 710 which determines if the player won their last match. Even though Player 2 would have Tower6 814 and Tower17 818 remaining, in this embodiment it is preferred to force the player into matches against bots, with guaranteed wins, to prevent the player (e.g. Player 2) from losing all of their towers in a very small amount of time. Such a scenario may cause the player to quit the game permanently or take a break. By forcing matches against bots immediately after losing a tower, the player will typically have a few large buildings in play which may incentivize play. Ensuring bot matches after a large loss can act as a stoploss to maintain the player's progress

When a match is created, the players engage in a 1v1 set of games in a best-of style. The size of the best-of game series may be determined by the size of the two towers in play. For example:
Tower size 0-4, best of 3 games.
Tower size 5-10, best of 5 games.
Tower size 11-20, best of 7 games.
Tower size 21+, best of 9 games.

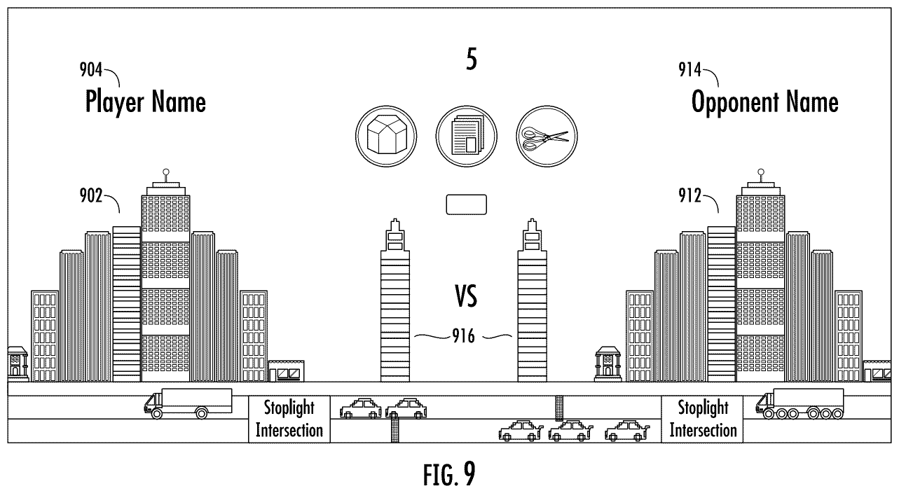

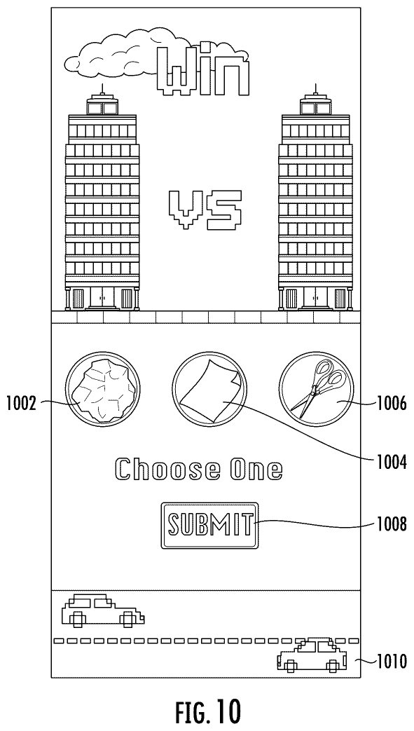

FIG. 9 shows an example initial game play interface. The interface 900 depicts the user's city 902 and name 904 and the opponent's city 912 and name 914. The interface 900 may also show the tower height 916 that is at stake for the match. A matchplay interface 1000 is shown in FIG. 10. The matchplay interface presents the user with three individually selectable icons, rock 1002, paper 1004 and scissors 1006 and a submit button 1008. At the bottom of the interface 1000 is a game progress bar 1010 that displays, by way of cars moving on a roadway, which of the two players is winning the match. In a rock-paper-scissors game, each player must make a decision to play one of the three options (rock, paper or scissors) within a timeframe, e.g. 10 seconds. If a player fails to make a decision in time, a choice is made for them at random. If the players select the same option, the game is repeated until there is a victor for a contest. The status of the best-of series is represented in game by cars moving in the street in each direction. The match ends once a player wins more than half of the available games.

### Bot Methodology

Bots will be available for players to play against in the best of 3 sized towers (0-4). These bots mimic new players and have a random and small number of small buildings. The bots make random choices unless they win one game of the best of 3. If that happens, the bot submits the losing option of each game until the actual player wins the match. This lets the player to maintain a favorable win percentage and improve their ad frequency variable. After a player plays against a few bots, they will be eligible to risk actual buildings.

### Ad Frequency

The variable ad frequency is expressed as a decimal and represents the percentage of matches that will have an ad shown between them. For example, an ad frequency of 1 would mean that an ad is played before every game and 0.5 would mean that an ad is played before every other game. The ad frequency variable is different for each player. It is dynamic and takes into account many factors including but not limited to:
Average playtime per session
Time since last session
The player's win percentage overall, in the session, and recently
City size and rate of change
Largest recent wins and losses

### Seasons

Game play will depend upon different seasons. In one embodiment, each season may last a month and sets a timer guaranteeing that all the rules apply in that time frame. This gives a chance for the game to balance everything based off of projected ad revenue.

In a new season, the various parameters of the game play may be configured by the game administrator, including:
Building sizes may be converted to different sizes
New Tournaments
New choice based games
New best-of thresholds

### Matchmaking

Matchmaking can be an important aspect of the player experience. The main purposes of the matchmaking are to eliminate loading/searching screens, maintain the players' sense of skill and fairness, and maximize tolerable ad revenue. Two alternative configurations of matchmaking will be described herein. The game administrators may be able to switch between these methodologies at any time.

### 1. Simple

In the simple system, each player is matched to another player in a first come first served basis where the largest common building between the two players is played. This style of matchmaking is possible because the players will play for a level one building on a new plot if there is no common building. In most cases, this style will take too long to generate towers that are large enough to be redeemed for higher rewards, such as entry into tournaments.

### 2. Targeted

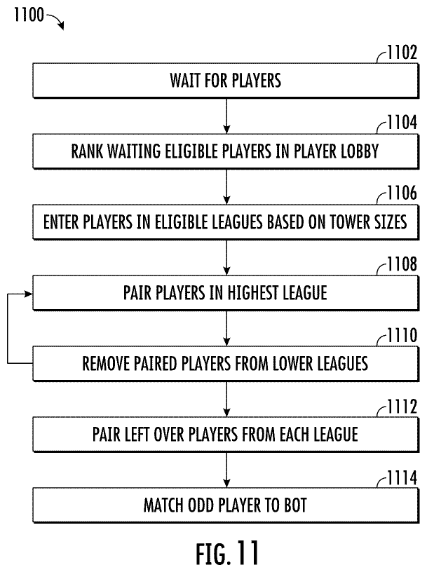

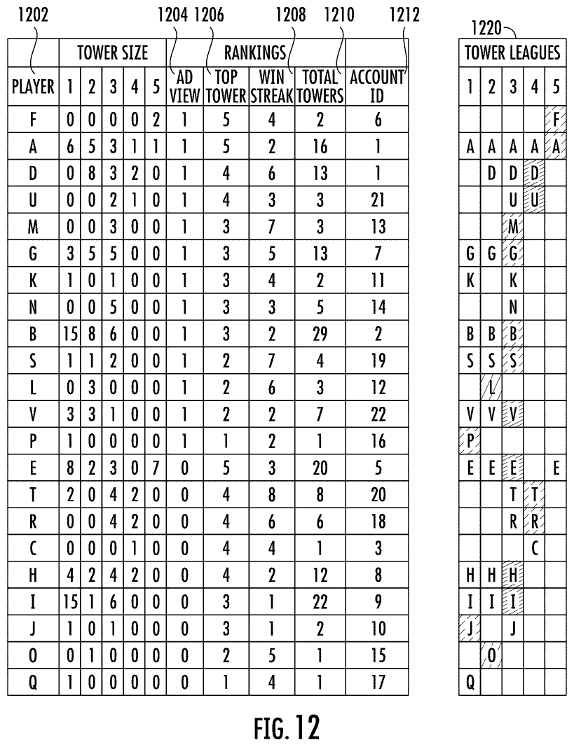

The second style of matchmaking is referred to herein as targeted matchmaking. In this configuration, all players that are eligible to risk their largest towers are ranked and paired with players that have their largest unlocked tower in common. FIG. 11 shows a process 1100 for targeted matchmaking. At step 1102, the process waits for players and forms a matchmaking lobby. At step 1104, the players are ranked. FIG. 12 shows a matchmaking lobby of players 1202, i.e. an eligible player pool, named A through U where the maximum tower size is 5. The players may be ranked as follows:
1. Are they currently viewing an AD? 1204
2. Largest tower size 1206
3. Current win streak 1208
4. Total value of all towers 1210
5. Account ID 1212

The player is then entered in each league that the player has an eligible tower for (step 1106). For example, if a player had a level 2, 4, and 5 tower, the player would be entered in the 2, 4 and 5 leagues. An eligible leagues table 1220 is show in FIG. 12. Matches are then awarded (step 1108) in the order from highest league to lowest league to encourage generation of higher level towers. All pairings are done by ranking. At step 1108, the highest ranked pair of players are matched and those matched players are removed from all lower leagues in which they were entered (step 1110). The process then returns to step 1108 for the next highest pair and so on until all possible pairings have been made. If there are an odd number of competitors in a league, those players are left unmatched and the unmatched player's lower league entries are considered.

Then the left over players are paired against each other (step 1112). If there is an odd number of players in the lobby and no available players can be found in time, the player is paired with a bot (step 1114) and a small tower (size 0 to 4) is played. Also, if a players' match disconnects before the first play is made then the remaining player is paired with a bot. If an ad is skipped and a match is not yet found, the player is paired with a bot to prevent waiting to find an opponent.

As described previously, players that may be waiting for matching in the lobby may actually be ineligible for a player v player match. A player can be ineligible for play for the following reasons:
An unfavorable session win percentage (<60%)
An unfavorable ad frequency variable

The player interface may include a tutorial section to allow a player to familiarize themselves with game play. The tutorial starts on the first match of the account. The tutorial plays 4 mock rounds and explains the rules of rock-paper-scissors, explains the best-of set mechanics, and shows what happens when you lose and when you win.

### Mock Round 1:

Explains the rules of rock-paper-scissors
Ends in victory and shows a tower being built

### Mock Round 2:

Plays the new level one building against another bot
Shows the countdown timer and best-of rules
Shows how the score is tallied.
Ends in victory and shows the tower growing to a level 2

### Mock Round 3:

Starts a new building match (level 0)
Shows about with a city of large towers that the player doesn't have.
Ends in victory and the player now has a level 1 and a level 2 building

### Mock Round 4:

The player is matched against a bout with a level 2 tower in play
The player loses this mock match and loses the building
The player ends the tutorial with one level 1 building and enters the actual matchmaking

By allowing players to hold multiple win streaks simultaneously, the matchmaking processes described herein ensure that a first player will never wager a high win streak against a player with a low win streak. This maintains fairness but also ensures continuity of game play because, provided there are at least two players in the eligible player pool, a game can always be played.

The game application may include a web based administration panel. Through the admin panel, an administrator can login and access a main dashboard to see a bird's eye view of the status of the game. The Admin panel dashboard may have the following modules:

### Matchmaking

The match making should have the following information and adjustable factors at a minimum:
Admin will have a provision to adjust the eligible winning rates.
Admin will have a provision to adjust the eligible ad frequency rates.
Admin will have a provision to adjust the early match rate win.
Admin will be able to see active user trends.
Admin will be able to see the analytics in depth tower histogram with active and dormant users.

### Advertisement

Admin will have a provision to add an advertisement. The advertisement page should have the following information at a minimum:
AD FREQUENCY RATE TRENDS
AD CPM TRENDS

### Tournaments

Admin will have a provision to create, delete and monitor the tournaments.
Admin will be able to adjust games rules, entry requirements, size, and price and bracket style.
Admin will be able to view users entered in the tournaments.
Admin will be able to verify the towers.

### Seasons

Admin will have a provision to announce season's rules and game changes.

### Accounts

Admin will be able to see all information for each user. Admin will be able to see history of all matches. Admin will be able to see stats and calculate the points. Admin will have provision to send the message players in games

To provide a concise and readily understandable example of a perpetual open tournament, the examples have been described with a simple game style between two contestants on an equal win streak. However, the person skilled in the art will readily recognize that broader forms of a perpetual open tournament are possible. In one embodiment, the contestants need not be on an exactly equal win streak, but instead, tournament organizers may consider it fair and reasonable to allow the matches between players that have near equivalent win streaks, i.e. that match within a predefined match criteria. For example, match criteria may specify that a player instance with a win streak x may be allowed to be matched with another player instance with a win streak y where that satisfies the condition:

$$y = x + / - n ,$$

where n specifies a proximity range. In one embodiment, the value n may be an absolute number, e.g. n=2, such that a player on 10 win streaks could be matched with a player with a win streak between 8 and 12. In one embodiment, the value n may be a dependent on the value of x. For example, if x<5, then the value of n may be 1; if 5<x<10, the value of n may be 2; if 10<x<20, the value of n may be 3; etc.

By allowing matches between close but non-equivalent win streaks, the tournament will allow a high level of game play because more matches will be able to take place amongst player instances with high win streaks, especially at times when there are a low numbers of players in the eligible player pool.

The games described herein are simple two player games with a single winner and a single loser. However, the tournament may allow games with more than two players and may allow more than winner and/or more than one loser. For example, to continue with the rock/paper/scissors example, a game may be conducted between 3 players simultaneously in either a best z contests or a first to z contest victories game series. Each contest may require a clear winner, e.g. one player (rock) triumphing over the other two players (both scissors). Alternatively, each player may score a point for each other player they beat in an individual contest. Other game scoring methods will be apparent to the person skilled in the art. At the end of the set number of contests, or when a player has reached a threshold number of contest points, a winner of the game may be declared. A single winner may be declared and have their win streak incremented while the player instances of the two losers are deleted. Alternatively, more than one winner may be declared, e.g. the top two ranked players may each be declared a winner and have their win streaks incremented while the sole loser has their player instance deleted. It will be apparent from this example, that each game does not need to be limited to a particular number of players. Other games may support a higher number of players. Further, games may include team games where all players on a winning team may be declared a winner while all players on a losing team may have their player instances deleted.

In one embodiment, a battle-royale style tournament may be conducted with monetary prizes offered for redeeming a win streak. In one embodiment, a win streak may be redeemed only if it consists of consecutive plays, i.e. the player does not pause or break during the tournament. This incentivizes the player to continue play which maximizes revenue from ad views.

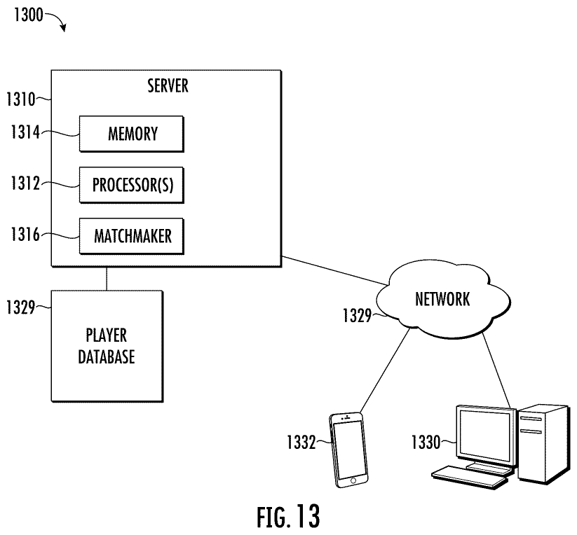

A game play tournament of the type described herein may be implemented on a network as depicted in FIG. 13. The network 1300 includes a server 1310 that accesses a player database 1320. The server may include one or more processors 1312 and one or more memories 1314 that include both random access memory (RAM) and read only memory (ROM). The memory may store programmed instruction sets, API programming etc. to enable the server 1310 to serve a game to a plurality of user devices including PC type computing devices 1330 and smartphone type computing devices 1332 via a network 1340 such as the Internet. It will be apparent to the person skilled in the art that the particular type of device and the particular network are not pertinent to the present embodiments and a wide variety of devices and network components are considered to be encompassed herein. The server 1310 may particularly include a matchmaking component 1316, e.g. a processor and associated memory that is programmed to generate matches between players using the matchmaking methodologies described herein and drawing from player instance information that may be stored in the player database 1320. The server 1310 may also include an ad server that is able to serve ads to the player devices 1330, 1332.

The server 1310 may receive commands and requests from users via the user devices 1330, 1332. The requests may include requests to be included in game play including in a tournament. From the requests, the server is able to generate an eligible player pool. The matchmaking module 1316 may process the eligible player pool to create matches between eligible players. The server 1310 may then conduct the match between matched players by displaying appropriate game play graphics on the user devices 1330, 1332.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for conducting a multiplayer tournament, the method comprising:
(A) establishing a pool of eligible players wherein players of the pool of eligible players may have multiple win streaks simultaneously associated to them;
(B) searching the pool of eligible players to match a set of players meeting a matching criteria;
(C) establishing a win streak at stake for each matched player of the set of players;
(D) conducting a game between the set of players;
(E) determining at least one winning player of the set of players as a winner of the game; and
(F) incrementing the win streak at stake for each of the at least one winning player.

2. The method of claim 1 wherein the matching criteria comprises that each of the players have an equal win streak, wherein the equal win streak is established as the stake for the game.

3. The method of claim 2 wherein the set of players comprises two players.

4. The method of claim 2 wherein searching the pool of eligible players comprises determining the highest common win streak between at least two players and matching the at least two players with the highest common win streak.

5. The method of claim 4 comprising deleting the win streak at stake from any players of the set of players that are not the at least one winner of the game.

6. The method of claim 2 wherein, when no common win streak exists for the set of players, setting zero win streaks as the stake for the game.

7. The method of claim 1 wherein, when the set of players comprises less than a minimum number of players for the game and a highest common win streak of the set of players is less than a threshold maximum win streak:
(A) incorporating at least one automated bot into the set of players; and
(B) controlling the bot so that the bot loses the game.

8. The method of claim 1 comprising conducting steps (B) to (F) repeatedly to form a tournament comprising multiple games, wherein steps (B) to (F) are conducted repeatedly for at least one of a predetermined period of time or a predetermined number of games.

9. A method for matchmaking in an online game between multiple players, the method comprising:
(A) establishing a pool of eligible players for an online game wherein players of the pool of eligible players may have multiple win streaks simultaneously associated to them;
(B) receiving a request from a first player of the pool of eligible players to play a match of the online game;
(C) determining at least one second player with a win streak equal to at least one of the win streaks associated to the first player;
(D) matching the first player and the at least one second player for the match of the online game;
(E) setting one of the equal win streaks as a stake for the match;
(F) conducting the online game and determining at least one winner of the match; and
(G) incrementing the staked win streak for the at least one winner of the match.

10. The method of claim 9 comprising searching the pool of eligible players to determine the at least second player.

11. The method of claim 10 comprising determining the highest common win streak between the first player and the at least one second player and setting the highest common win streak as the stake for the match.

12. The method of claim 10 wherein when the searching determines that no second player with an equal win streak is available to match the first player, creating a new zero win streak for the first player and a selected at least one second player and setting the zero win streak as the stake for the match between the first player and the selected at least one second player.

13. The method of claim 9 comprising;
(A) determining that the highest win streak associated to the first player is less than a predetermined minimum win streak;
(B) wherein determining at least one second player comprises:
(a) creating a bot with a win streak equal to the highest win streak of the first player;
(b) setting the highest win streak as the stake for a match between the first player and the bot; and
(c) conducting the online game between the first player and the bot comprising controlling the bot so that the bot loses the match.

14. A method for conducting a multiplayer tournament, the method comprising:
(A) establishing a pool of eligible player instances wherein each player instance is associated with a player and a win streak, and wherein a player may have multiple player instances associated to them simultaneously;
(B) matching a set of player instances from the pool of eligible player instances according to matching criteria;
(C) conducting a game between the set of players associated with the matched player instances;
(D) determining at least one winning player of the set of players as a winner of the game; and
(E) incrementing the win streak of the matched player instance associated with each of the at least one winning player.

15. The method of claim 14 wherein matching the set of player instances comprises preferentially matching player instances in order from highest win streak to lowest win streak.

16. The method of claim 14 wherein the matching criteria are based on the win streaks of the player instances.

17. The method of claim 16 wherein the matching criteria requires that the win streaks of matched player instances are within a maximum number of each other.

18. The method of claim 17 wherein the matching criteria requires that the win streaks of matched player instances are equal.

19. The method of claim 16 comprising, when the matching process fails to match any of the player instances of a player to another player instance of the pool of eligible player instances, creating a new player instance for the player, the new player instance comprising a win streak value of zero.

20. The method of claim 14 comprising deleting the matched player instance associated with each player that is not the at least one winning player.

21. The method of claim 14 comprising representing a player instance on a graphic user interface as a tower, wherein the height of the tower is dependent on the win streak of the respective player instance.

22. The method of claim 14 comprising conducting steps (A) to (E) repeatedly to form a tournament comprising multiple games, wherein steps (A) to (E) are conducted repeatedly for at least one of a predetermined period of time or a predetermined number of games.

23. The method of claim 14 comprising redeeming a win streak of at least a threshold minimum number for a reward.

24. The method of claim 23 wherein the reward comprises entry into a tournament.

25. The method of claim 23 wherein the redeeming win streak consists of only consecutive plays in a battle royale style tournament.

26. The method of claim 14 comprising redeeming a collection of win streaks of a collection of player instances for a reward if the collection of win streaks meets a minimum requirement.

27. The method of claim 26 wherein the minimum requirement comprises that the collection of win streaks comprises only consecutive plays in a battle royale style tournament.

28. A system comprising:
(A) a server configured to communicate with a plurality of player devices through a network; and
(B) a database that is operatively associated with the server and that stores player data;
(C) wherein the server is programmed to:
(a) establish a pool of eligible players wherein players of the pool of eligible players may have multiple win streaks simultaneously associated to them within the database;
(b) search the pool of eligible players to match a set of players meting a matching criteria;
(c) establish a win streak at stake for each matched player of the set of players;
(d) conduct a game between the set of players;
(e) determine at least one winning player of the set of players as a winner of the game; and
(f) increment the win streak at stake for each of the at least one winning player.

29. A system comprising:
(A) a server configured to communicate with a plurality of player devices through a network; and
(B) a database that is operatively associated with the server and that stores player data;
(C) wherein the server is programmed to:
(a) establish a pool of eligible players for an online game wherein players of the pool of eligible players may have multiple win streaks simultaneously associated to them within the database;
(b) receive a request from a first player of the pool of eligible players via a first player device to play a match of the online game;
(c) determine at least one second player with a win streak equal to at least one of the win streaks associated to the first player;
(d) match the first player and the at least one second player for the match of the online game;
(e) set one of the equal win streaks as a stake for the match;
(f) conduct the online game and determining at least one winner of the match; and
(g) increment the staked win streak for the at least one winner of the match.

30. A system comprising:
(A) a server configured to communicate with a plurality of player devices through a network; and
(B) a database that is operatively associated with the server and that stores player data;
(C) wherein the server is programmed to:
(a) establish a pool of eligible player instances wherein each player instance is associated with a player and a win streak, and wherein a player may have multiple player instances associated to them simultaneously within the database;
(b) match a set of player instances from the pool of eligible player instances according to matching criteria;
(c) conduct a game between the set of players associated with the matched player instances;
(d) determine at least one winning player of the set of players as a winner of the game; and
(e) increment the win streak of the matched player instance associated with each of the at least one winning player.
